(19) United States
(12) Patent Application Publication
(10) Pub. No.: US 2022/0414497 A1
(43) Pub. Date: Dec. 29, 2022

(54) ECOMMERCE APPLICATION OPTIMIZATION FOR RECOMMENDATION SERVICES

(71) Applicant: NCR Corporation, Atlanta, GA (US)

(72) Inventor: Itamar David Laserson, Givat Shmuel (IL)

(21) Appl. No.: 17/361,581

(22) Filed: Jun. 29, 2021

(51) Int. Cl. G06N 5/04; G06Q 30/06; G06N 20/00

(52) U.S. Cl. CPC G06N 5/04; G06Q 30/0631; G06N 20/00; G06Q 30/0201

(57) ABSTRACT

An ecommerce application (app) is enhanced to call an optimizer service during a user session with the app. The optimizer service calls a recommendation service used by the app and returns recommended products to display during the user session within the app. A machine-learning model of the optimizer service is called with the session contexts or states for which the app is permitting recommendations along with the physical space that the app is permitting for recommendations within each context. The model returns specific recommendations and specific types of recommendations selected from the recommended products returned by the recommendation service and identifies a total number of recommendations and recommendation types for each context within the allotted space permitted by the app. The determined recommendations within their corresponding contexts are communicated from the optimizer service to the app and displayed to the user during the session.

### BACKGROUND

Most user-based ecommerce applications (apps) are already interfaced to product recommendation engines (services) to produce and present recommendations to user. However, using the recommended products effectively within the ecommerce apps to achieve an optimal conversion rate (purchase rate of recommended products) is challenging.

Many retailers are losing substantial sales opportunities due to poor utilization of recommendation services. Eventually, the effectivity of the recommendation service is measured by how many product offers turned into actual sales (conversions).

Some the challenges facing a retailer how to effectively balance between “exploration” versus “exploitation;” deciding on how many recommendations should be included within the allotted available space within the ecommerce app; deciding how to utilize a given recommendation engine across different ecommerce applications of the retailer; and deciding how to utilize the recommendation engine within different usage contexts of a given ecommerce app.

Currently, these challenges are handled by the ecommerce applications, largely through heuristics and educated guesses. Furthermore, switching to a different recommendation engine or even a different version of an existing recommendation engine requires changes to the ecommerce app.

Overall, the utilization of the recommendation engine is suboptimal, resulting in lost opportunities for the retailers.

### SUMMARY

In various embodiments, methods and a system for ecommerce application optimization for recommendation services are presented.

According to an aspect, a method for ecommerce application optimization for recommendation services is presented. Available recommendation criteria are obtained from an ecommerce application (app) for presenting recommendations to a user during a user session with the ecommerce app. Recommendations are obtained from a recommendation service using at least a portion of the available recommendation criteria. Select recommendations and select criteria for each select recommendation are obtained based on the available recommendation criteria and the recommendations. The select recommendations and the select criteria are provided back to the ecommerce app to control a presentation and a timing of the presentation for each of the select recommendations during the user session.

### BRIEF DESCRIPTION OF THE DRAWINGS

FIG. 1 is a diagram of a system for ecommerce application optimization for recommendation services, according to an example embodiment.

FIG. 2 is a diagram of a method for ecommerce application optimization for recommendation services, according to an example embodiment.

FIG. 3 is a diagram of another method for ecommerce application optimization for recommendation services, according to an example embodiment.

### DETAILED DESCRIPTION

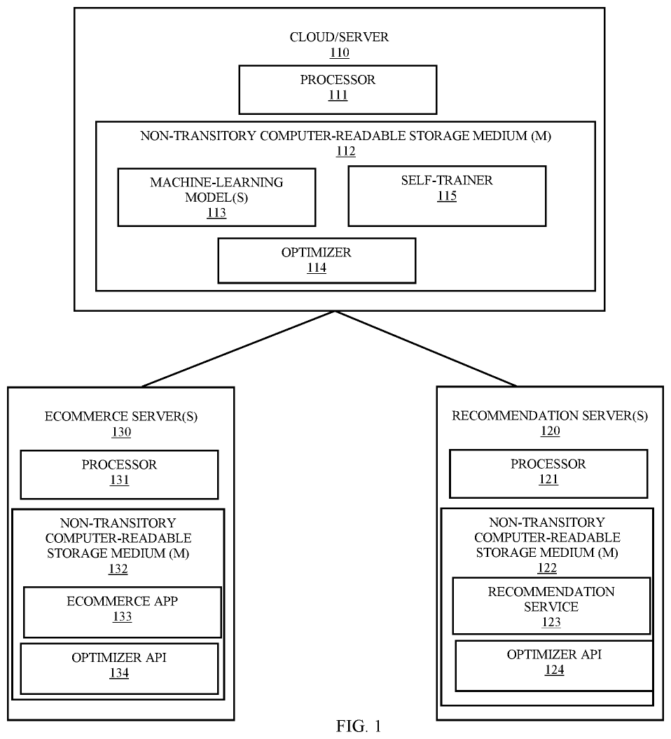

FIG. 1 is a diagram of a system 100 for ecommerce application optimization for recommendation services, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of ecommerce application optimization for recommendation services presented herein and below.

As will be discussed in the various embodiments that follow, the teachings provide optimization techniques for optimizing conversion rates of recommendation engines (services) within an ecommerce application (app). An optimizing service is provided that sits between an existing ecommerce application and an existing recommendation service. An optimization Application Programming Interface (API) is provided to the ecommerce app and the recommendation service. The optimization service is based off a trained machine-learning model that can self-train itself for achieving optimal conversion rates (purchases of recommended products that are recommended by the recommendation service) through an automated feedback mechanism.

As used herein “exploitation” refers to features that aim to improve a consumer's experience within a given ecommerce app by predicting what the consumer intended to purchase and allowing the consumer to quickly and easily navigate the app and purchase items that were intended to be purchased without the user having to manually search and navigate through interface screens of the app to find the items. “Exploration” refers to features that that aim to increase the consumer's basket of items within the app by exposing them to new items that they might want to add but did not originally intend to add them during their shopping session with the app.

The “real estate” (physical space) available for recommended products within the app is limited. Exploration naturally yields the highest value for a given retailer, but exploitation is required to provide a decent and acceptable level of consumer experience with the app.

The techniques provided herein and below optimizes the real estate available within the app between the exploration features and the exploitation features for purposes of optimizing a given retailer's conversion rates (and thereby revenues) on recommended products.

System 100 comprises a cloud/server 110, a plurality of recommendation servers 120, and a plurality of ecommerce servers 130.

Cloud/Server 110 comprises at least one processor 111 and a non-transitory computer-readable storage medium 112. Medium 112 comprises executable instructions for one or more machine-learning models (algorithms) 113, an optimizer 114, and a self-trainer 115. The executable instructions when executed by processor 111 from the medium 112 cause processor 111 to perform operations discussed herein and below with model(s) 113, optimizer 114, and self-trainer 115.

Each recommendation server 120 comprises a processor 121 and a non-transitory computer-readable storage medium 122. Medium 122 comprises executable instructions for a recommendation service (engine) 123 and an optimizer API 124. The executable instructions when executed by processor 121 from medium 122 cause processor 121 to perform operations discussed herein and below with respect to engine 123 and optimizer API 124.

Each ecommerce server 130 comprises a processor 131 and a non-transitory computer-readable storage medium 132. Medium 132 comprises executable instructions for an ecommerce app 133 and an optimizer API 134. The executable instructions when executed by processor 131 from medium 132 cause processor 131 to perform operations discussed herein and below with respect to ecommerce app 133 and optimizer API 134.

Initial training of model 113 is based on a retailers past presented or rendered recommendations within the ecommerce app 133 and the outcome of those recommendations (converted (purchased) and not converted (not purchased)) with consumers. The input provided from these past recommendations for training model 113 include: ecommerce app type, version number, and device type of the device associated with an ecommerce user session (e.g., Apple® iPhone®, Google® phone, Windows® Personal Computer (PC), etc.); recommendation context during the user session with ecommerce app 133 (shopping list, mobile shopper, payment mode, substitution mode, —a state of the session); data and time of the user session; and a list of recommended products presented during the session. For each recommended product the following information is provided for training: space provided for this specific recommended product within the ecommerce app 133, recommended type (exploitation or exploration) for the product, and recommendation score. The initial training data is also tagged with converted or not converted so model 113 can configure itself based on those user sessions where conversions were made versus those that did not have conversions.

The output of model 113 provides instructions for how (manner), where, and when to place each recommendation provided by recommendation service 133 within a given user session with ecommerce app 133.

An enhancement is made to an existing ecommerce app to use optimization API 134 creating an enhanced ecommerce app 133. Ecommerce app 133 calls optimizer 113 using API 134 for product recommendations during a user session with app 133 and provides as input the recommendation context, date and time, and provided area (screen space for the recommendation). It is to be noted that the app version and the device type can be automatically obtained based on metadata available with the API call made from app 133. Optimizer 114 receives the API call with the provided input and obtains the metadata for the additional input needed for the user session from the API call.

Next, optimizer 114 calls the recommendation service through optimizer API 124 and receives a list back of recommended products (with the product names, recommendation types, and recommendation scores) from recommendation service 123. The input used during training of model 114 is then provided by optimizer 114 to model 113 and model 113 returns as output a total number of specific products to use, which specific products to recommend, and where to place them within app 133 during the user session to get a maximum likelihood of conversion for each recommended product. This information is provided via API 134 to app 133.

Additionally, trainer 115 will apply random changes to the outputs provided by model 113 and based on actual conversions or non-conversions will retrain model 113 and optimize itself for optimal conversions on recommended products during user sessions with app 133.

System 100 is agnostic to both app 133 and recommendation service 123 and self-learns and self-trains model 113 to optimize utilization of recommendation service 123 within app 133.

The output of model 113 provides how many of the recommended products to use with app 133 during a given session with a user. App 133 may provide X area of space for recommendations within an “active order” state or context of the user session with app 133, Y area of space for recommendations within in a “no active order” state or context of user session with app 133, and Z area of space for recommendation within a “payment” state or context of the user session with app 133. Model 113 is trained to identify how many different recommendations to provided within each area X, Y, and Z. Increasing the total number of recommended products within each area might increase opportunities but at the same time might decrease user attention when the recommended products are too small to be noticed by the user. The initial training on model 113 allow it to optimize the total number of product recommendations based on the context within app 133 for the user session and based on the available area provided by app 133.

Additionally, it is noted that the web-based version of app 133 is not the same and the mobile app version of app 133. The user browsing method, the usage contexts and the real-estate available for recommendations are completely different. Model 113 uses the app version, user device type, and usage context as input (factors) for optimally allocating recommendations within the contexts and real estate available within app 133.

Further, model 113 accounts for the user session itself based on the input factor associated with the usage context (state) of app 133 during the session. When the consumer is building a shopping list at home in the evening they are likely to be more open for explorations, however when they are on a lunch break or at a store using mobile shopper they are obviously going to be less likely to be responsive to explorations. The date and time is provided as input to model 113 as one of the factors upon which model 113 is configured. In an embodiment, the location of the user device many also be provided as input during training to model 113. Thus, model 113 optimally determines when exploitation recommendations should be provided to the user session within app 133 versus when exploration recommendations should be provided.

System 100 provides a trained machine-learning model 113 that takes away the guesswork that retailers use when providing product recommendations during a user session with an ecommerce app 133. The model 113 returns how many recommendations to use, where each recommendation is to be used (within the session state or app context of the session), and when exploration versus exploitation recommendations are to be used. This output is provided via API 134 and integrated into the running version of app 133 during its session with the user. The system 100 is agnostic to app 133 and recommendation service 123 meaning that neither app is evaluated or modified to improve what the app 133 and the service 123 were originally intended to do (e.g., app 133 is intended to provide user sessions for shopping while service 123 is intended to provided product recommendations for the sessions to app 133); rather, system 100 optimize what how recommendations are physically displayed and presented within app 133 during sessions and decides how many of the recommendations and the type of recommendations (exploration versus exploitation) and the timing and context of presenting the selected recommendations within app 133 during the session. In this way, the recommendation service's recommendations are optimally selected provided within sessions of users with app 133 using machine learning. Model 113 is also self-trained by self-trainer 115 by randomly changing output of model 113 and evaluating conversion rates by the user to retrain model 113 based on actual results or feedback. In this way, an automated feedback loop and training occurs with model 113.

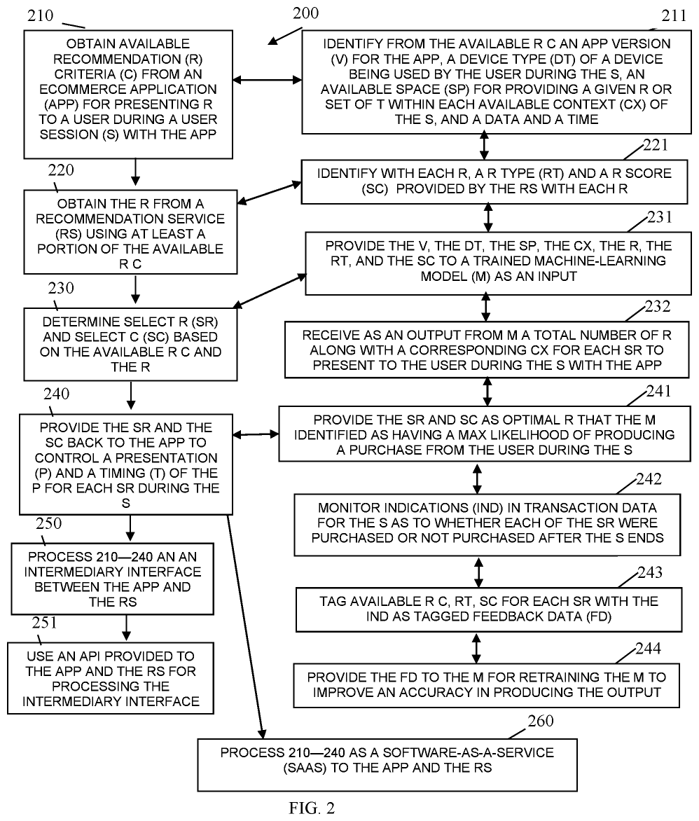

The above-referenced embodiments and other embodiments are now discussed with reference to FIG. 2.

FIG. 2 is a diagram of a method 200 for ecommerce application optimization for recommendation services, according to an example embodiment. The software module(s) that implements the method 200 is referred to as an “ecommerce app recommendation optimizer.” The ecommerce app recommendation optimizer is implemented as executable instructions programmed and residing within memory and/or a non-transitory computer-readable (processor-readable) storage medium and executed by one or more processors of one or more devices. The processor(s) of the device(s) that executes the ecommerce app recommendation optimizer are specifically configured and programmed to process the ecommerce app recommendation optimizer. The ecommerce app recommendation optimizer has access to one or more network connections during its processing. The connections can be wired, wireless, or a combination of wired and wireless.

In an embodiment, the device that executes the ecommerce app recommendation optimizer is cloud 110. In an embodiment, the device that executes ecommerce app recommendation optimizer is server 110.

In an embodiment, the ecommerce app recommendation optimizer is all of, or some combination of model 113, optimizer 114, self-trainer 115, optimizer API 124, and/or optimizer API 124.

At 210, ecommerce app recommendation optimizer obtain available recommendation criteria from an ecommerce app for presenting recommendations to a user during a user session with the ecommerce app.

In an embodiment, at 221, the ecommerce app recommendation optimizer identifies from the available recommendation criteria an app version for the ecommerce app, a device type of a device being used by the user during the session, an available space within the ecommerce app for providing a given recommendation or a given set of recommendations within each available context (or state) of the session, and a current date and a current time.

At 220, the ecommerce app recommendation optimizer obtains the recommendations for the session from a recommendation service (that is used by the ecommerce app) using at least a portion of the available recommendation criteria.

In an embodiment of 211 and 220, at 221, the ecommerce app recommendation optimizer identifies with each recommendation, a recommendation type (exploration or exploitation), and a recommendation score provided by the recommendation service with each recommendation based on the user session.

At 230, the ecommerce app recommendation optimizer determines select recommendations and select criteria from the recommendations based on the available recommendation criteria and the recommendations (include each recommendation type and each recommendation score).

In an embodiment of 221 and 230, at 231, the ecommerce app recommendation optimizer provides the app version, device type, the available space per context, the contexts, the recommendations, the recommendation types, and the recommendation scores to a trained machine-learning model as input.

In an embodiment of 231 and at 232, the ecommerce app recommendation optimizer receives as an output from the model a total number of recommendations along with a corresponding context for each select recommendation to present to the user during the session with the ecommerce app.

At 240, the ecommerce app recommendation optimizer provides the select recommendations and the second criteria back to the ecommerce app to control a presentation and a timing of the presentation for each select recommendation during the session with the user.

In an embodiment of 232 and 240, at 241, the ecommerce app recommendation optimizer provides the select recommendations and the select criteria as optimal recommendations that the model identified as having a maximum likelihood of producing a purchase from the user during the session.

In an embodiment of 241 and at 242, the ecommerce app recommendation optimizer monitors indications in transaction data for the session as to whether each of the select recommendations were purchased or were not purchased by the user after the session ends.

In an embodiment of 242 and at 243, the ecommerce app recommendation optimizer tags the available recommendation criteria, the recommendation types, and the recommendation scores with the indications as tagged feedback data.

In an embodiment of 243 and at 244, the ecommerce app recommendation optimizer provides the tagged feedback data to the model for retraining the model to improve an accuracy in producing the output and thereby improve the conversion rate prediction being made by the model.

In an embodiment, at 250, the ecommerce app recommendation optimizer (210-240) is processed as an intermediary interface between the ecommerce app and the recommendation service.

In an embodiment of 250 and at 251, the ecommerce app recommendation optimizer uses an API provided to the ecommerce app and the recommendation service for processing as the intermediary interface between ecommerce app and the recommendation service.

In an embodiment, at 260, the ecommerce app recommendation optimizer (210-240) is processed as a Software-as-a-Service (SaaS) to the ecommerce app and the recommendation service.

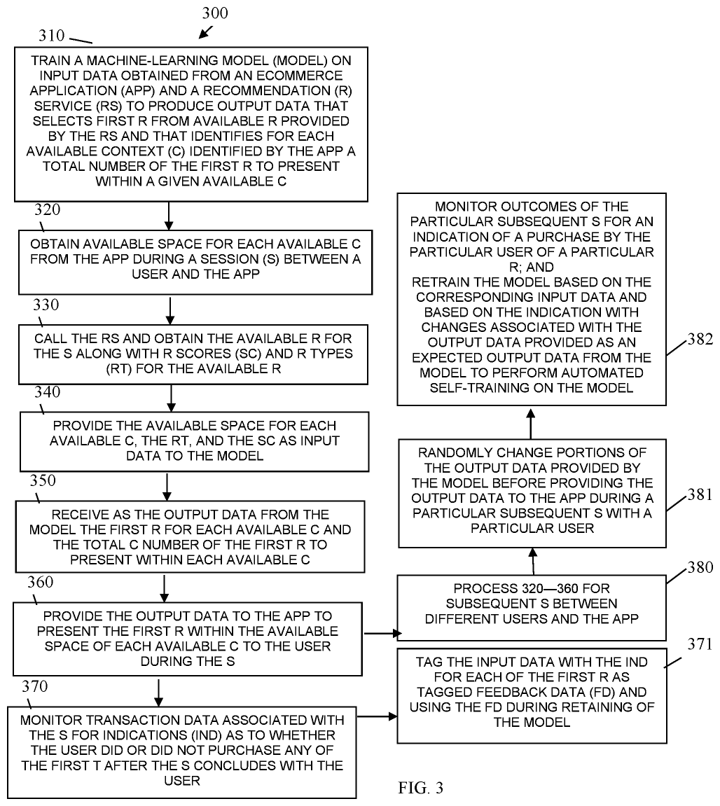

FIG. 3 is a diagram of another method 300 for ecommerce application optimization for recommendation services, according to an example embodiment. The software module(s) that implements the method 300 is referred to as a “real-time recommendation user-session optimizer.” The real-time recommendation user-session optimizer is implemented as executable instructions programmed and residing within memory and/or a non-transitory computer-readable (processor-readable) storage medium and executed by one or more processors of one or more devices. The processor(s) of the device(s) that executes the real-time recommendation user-session optimizer are specifically configured and programmed to process the real-time recommendation user-session optimizer. The real-time recommendation user-session optimizer has access to one or more network connections during its processing. The network connections can be wired, wireless, or a combination of wired and wireless.

In an embodiment, the device that executes the real-time recommendation user-session optimizer is cloud 110. In an embodiment, the device that executes the real-time recommendation user-session optimizer is server 110.

In an embodiment, the real-time recommendation user-session optimizer is all of, or some combination of predictor 113, optimizer 114, self-trainer 115, optimizer API 124, optimizer API 134, and/or method 200.

At 310, the real-time recommendation user-session optimizer trains a machine-learning model (model) on input data obtained from an ecommerce app and a recommendation service to produce output that selects first recommendations from available recommendations provided by the recommendation service and that identifies for each available context identified by the ecommerce app a total number of the first recommendations to present within a given available context.

At 320, the real-time recommendation user-session optimizer obtains available space for each available context from the ecommerce app during a session between a user and the ecommerce app.

At 330, the real-time recommendation user-session optimizer calls the recommendation service and obtains the available recommendations for the session along with recommendation scores and recommendation types for the available recommendations.

At 340, the real-time recommendation user-session optimizer provides the available space for each available context, the recommendation types, and the recommendation scores as input data to the model.

At 350, the real-time recommendation user-session optimizer receives as the output data from the model the first recommendations for each available context and a total context number of the first recommendations to present within each available context.

At 360, the real-time recommendation user-session optimizer provides the output data to the ecommerce app to present the first recommendations within the available space of each available context to the user during the session.

In an embodiment, at 370, the real-time recommendation user-session optimizer monitors transaction data associated with the session for indications as to whether the user did or did not purchase any of the first recommendations after the session concludes between the user and the ecommerce app.

In an embodiment of 370 and at 371, the real-time recommendation user-session optimizer tags the input data with the indications for each of the first recommendations as tagged feedback data and the real-time recommendation user-session optimizer uses the feedback data during retraining of the model.

In an embodiment, at 380, the real-time recommendation user-session optimizer processes 320-360 for subsequent sessions between different users and the ecommerce app.

In an embodiment of 380 and at 381, the real-time recommendation user-session optimizer randomly changes portions of the output data provided by the model before providing the output data to the ecommerce app at 360 during a particular subsequent session with a particular user.

In an embodiment of 381 and at 382, the real-time recommendation user-session optimizer monitors outcomes of the particular subsequent session for an indication of a purchase by the particular user of a particular recommendation. The real-time recommendation user-session optimizer retrains the model based on the corresponding input data and based on the indication with changes associated with the output data (that were randomly made) provided as an expected output data from the model to perform automated self-training on the model.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
obtaining available recommendation criteria from an ecommerce application (app) for presenting recommendations to a user during a user session with the ecommerce app;
obtaining the recommendations from a recommendation service using at least a portion of the available recommendation criteria;
determining select recommendations and select criteria for each select recommendation based on the available recommendation criteria and the recommendations; and
providing the select recommendations and the select criteria back to the ecommerce app to control a presentation and a timing of the presentation for each of the select recommendations during the user session.

2. The method of claim 1, wherein obtaining the available recommendation criteria further includes identifying from the available recommendation criteria an application version for the ecommerce app, a device type of a user-device being used for the user session, an available space for providing a given recommendation or set of recommendations within each available context of the user session, and a date and a time.

3. The method of claim 2, wherein obtaining the recommendations further includes identifying with each recommendation a recommendation type and a recommendation score provided by the recommendation service with each recommendation.

4. The method of claim 3, wherein determining further includes providing the application version, the device type, the available space available for each available context, the data and the time, each recommendation type, and each recommendation score to a trained machine-learning model as an input.

5. The method of claim 4, wherein providing the input to the trained machine-learning model further includes receiving as an output from the trained machine-learning model a total number of recommendations identified as the select recommendations along with a corresponding available context for each select recommendation to present during the user session within the ecommerce app.

6. The method of claim 5, wherein providing the select recommendations and the select criteria further includes providing the select recommendations and the select criteria as optimal recommendations that the trained machine-learning model identified as having a maximum likelihood of producing a purchase by the user during the user session.

7. The method of claim 6 further comprising, monitoring for indications in transaction data of the user session as to whether each of the select recommendations were purchased or not purchased by the user after the user session concludes.

8. The method of claim 7, wherein monitoring further includes tagging the available recommendation criteria, the recommendation types, and the recommendation scores for each select recommendation with the indications as tagged feedback data.

9. The method of claim 8, wherein tagging further includes providing the feedback data to the trained machine-learning model for retraining the trained machine-learning model to improve an accuracy in producing the output by the trained machine-learning model.

10. The method of claim 1 further comprising, processing the method as an intermediary interface between the ecommerce app and the recommendation service.

11. The method of claim 10, wherein processing further includes using an Application Programming Interface (API) provided to the ecommerce app and the recommendation service for processing the intermediary interface.

12. The method of claim 1 further comprising, processing the method as a Software-as-a-Service (SaaS) to the ecommerce app and the recommendation service.

13. A method, comprising:
training a machine-learning model on input data obtained from an ecommerce application (app) and a recommendation service to produce output data that selects first recommendations from available recommendations provided by the recommendation service and that identifies for each available context identified by the ecommerce app a total context number of the first recommendations to present within a given available context;
obtaining available space for each available context from the ecommerce app during a session between a user and the ecommerce app;
calling the recommendation service and obtaining the available recommendations for the session along with recommendation scores and recommendation types for the available recommendations;
providing the available space for each available context, the recommendation types, and the recommendation scores as the input data to the trained machine-learning model;
receiving as the output data from the trained-machine learning model the first recommendations for each available context and the total context number of first recommendations to present within each of the available context; and
providing the output data to the ecommerce app to present the first recommendations within the available space of each available context to the user during the session.

14. The method of claim 13 further comprising monitoring transaction data associated with the session for indications as to whether the user did or did not purchase any of the first recommendations after the session concludes with the user.

15. The method of claim 14 further comprising tagging the input data with the indications for each of the first recommendations as tagged feedback data and using the tagged feedback data during retraining of the trained machine-learning model.

16. The method of claim 13 further comprising, processing the obtaining, the calling, the providing of the available space, and providing the output data for subsequent sessions between different users and the ecommerce app.

17. The method of claim 16 further comprising, randomly changing portions of the output data provided by the trained-machine learning mode before providing the output data to the ecommerce app during a particular subsequent session with a particular user.

18. The method of claim 17 further comprising:
monitoring outcomes of the particular subsequent session for an indication of a purchase by the particular user of a particular recommendation; and
retraining the trained machine-learning model based on the corresponding input data and based on the indication with changes associated with the output data provided as an expected output data from the trained machine-learning model to perform automated self-training on the trained machine-learning model.

19. A system, comprising:
an ecommerce server;
a recommendation server; and
a cloud or a server;
wherein the ecommerce server configured to provide a space and a context within an ecommerce application (app) for which recommendations can be provided for presenting during user sessions with the ecommerce app, receive a total number of selected recommendations per context from the cloud or server, and present each of the selected recommendations within the corresponding context during the user sessions;
wherein the recommendation service is configured to provide the recommendations for use to the cloud or the server along with recommendation types and recommendation scores for the recommendations;
wherein the cloud or the server is configured to: receive the space for each context from the ecommerce app, call the recommendation service to obtain the recommendations with the recommendation types and with the recommendation scores, determine the selected recommendations and the total number of the selected recommendations per context, and provide the total number of selected recommendations per context to the ecommerce app for the user sessions.

20. The system of claim 19, wherein the cloud or the server is configured to process a trained machine-learning mode to determine the selected recommendations and the total number of the selected recommendations per context for each session and to self-train the trained machine learning model based on outcomes associated with the sessions during which one or more of the selected recommendations were or were not purchased.
